(19) United States
(12) Patent Application Publication
(10) Pub. No.: US 2026/0299343 A1
(43) Pub. Date: Oct. 1, 2026

(54) DISPLAY DEVICE

(71) Applicant: LG ELECTRONICS INC., Seoul (KR)

(72) Inventors: Seho KIM, Seoul (KR); Jungmo MOON, Seoul (KR); Yongil KIM, Seoul (KR)

(73) Assignee: LG ELECTRONICS INC., Seoul (KR)

(21) Appl. No.: 19/546,185

(22) Filed: Feb. 20, 2026

(30) Foreign Application Priority Data
Mar. 31, 2025 (WO) PCT/KR2025/004126

(51) Int. Cl. G02F 1/1333; G02F 1/13357

(52) U.S. Cl. CPC G02F 1/133314; G02F 1/133382; G02F 1/133615

(57) ABSTRACT

A display device is disclosed. The display device may include a display panel, a frame disposed behind the display panel, a housing comprising a rear part disposed between the display panel and the frame and a side part intersecting the rear part and extending along a lower side of the display panel, a substrate coupled to the side part, and a plurality of light sources disposed on the substrate and configured to emit light, wherein the substrate may include a body extending along the lower side of the display panel, and an enlarged portion extending from the body forwards or backwards.

### CROSS-REFERENCE TO RELATED APPLICATION

Pursuant to 35 U.S.C. § 119, this application claims the benefit of earlier filing date and right of priority to International Application No. PCT/KR2025/004126, filed on Mar. 31, 2025, the contents of which are all incorporated by reference herein in its entirety.

### BACKGROUND OF THE INVENTION

### Field of the invention

The present disclosure relates to a display device.

### Description of the Related Art

With the development of the information society, demand for various kinds of display devices is increasing. In response to this demand, various kinds of display devices, such as LCDs (Liquid Crystal Displays), PDPs (Plasma Display Panels), ELDs (Electro-luminescent Displays), VFDs (Vacuum Fluorescent Displays) and OLEDs (Organic Light-Emitting Diodes) have recently been researched and used.

Thereamong, an LCD panel includes a TFT substrate and a color substrate, which face each other with a liquid crystal layer interposed therebetween, in order to display an image using light supplied from a backlight unit. In recent years, a great deal of research on a structure configured to improve radiation performance of an edge-lighting-type LCD in which the light source is disposed on the periphery of the display device is being conducted.

### SUMMARY OF THE INVENTION

It is an object of the present disclosure to solve the above and other problems.

Another object of the present disclosure may be to provide a structure in which heat dissipation performance around a communication unit is improved.

Another object of the present disclosure may be to provide a structure in which the surface area of a substrate around the communication unit is increased.

Another object of the present disclosure may be to provide a structure in which heat dissipation performance around a connector of the substrate is improved.

Another object of the present disclosure may be to provide a structure in which an opening is formed in a housing to which the substrate is coupled around the connector of the substrate.

Another object of the present disclosure may be to provide a structure in which the size of the opening in the housing, which is formed around the connector on the substrate, is minimized.

Another object of the present disclosure may be to provide a structure in which a cable is fastened to the connector of the substrate in a horizontal direction.

Another object of the present disclosure may be to provide a structure in which a board is disposed around the opening in the housing.

Another object of the present disclosure may be to provide a structure a structure in which a hole is formed in the substrate around the opening in the housing.

In order to accomplish the above and other objects, a display device according to one aspect of the present disclosure may include a display panel, a frame disposed behind the display panel, a housing comprising a rear part disposed between the display panel and the frame and a side part intersecting the rear part and extending along a lower side of the display panel, a substrate coupled to the side part, and a plurality of light sources disposed on the substrate and configured to emit light, wherein the substrate may include a body extending along the lower side of the display panel, and an enlarged portion extending from the body forwards or backwards.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 to 23 are views illustrating examples of a display device according to embodiments of the present disclosure.

### DETAILED DESCRIPTION

A description will now be given in detail according to exemplary embodiments disclosed herein, with reference to the accompanying drawings. For the sake of brevity of description with reference to the drawings, the same or equivalent components are denoted by the same reference numbers, and a description thereof will not be repeated.

In general, suffixes such as “module” and “unit” may be used to refer to elements or components. The use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to facilitate understanding of various technical features, and it should be understood that the embodiments presented herein are not limited by the accompanying drawings. As such, the present disclosure should be construed to extend to any alterations, equivalents and substitutes, in addition to those that are particularly set out in the accompanying drawings.

It is to be understood that, although the terms “first,” “second,” etc. may be used herein to describe various elements, these elements should not be limited by these terms. These terms are only used to distinguish one element from another.

When an element is referred to as being “coupled”, “fixed”, “mounted”, “connected” or “linked” to another element, a further element may be present between the one element and the other element. In addition, when an element is referred to as being “directly coupled”, “directly fixed”, “directly mounted”, “directly connected” or “directly linked” to another element, a further element may not be present between the one element and the other element.

A singular representation may include a plural representation unless the context clearly indicates otherwise.

In the present disclosure, it should be understood that the terms “comprises,” “includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

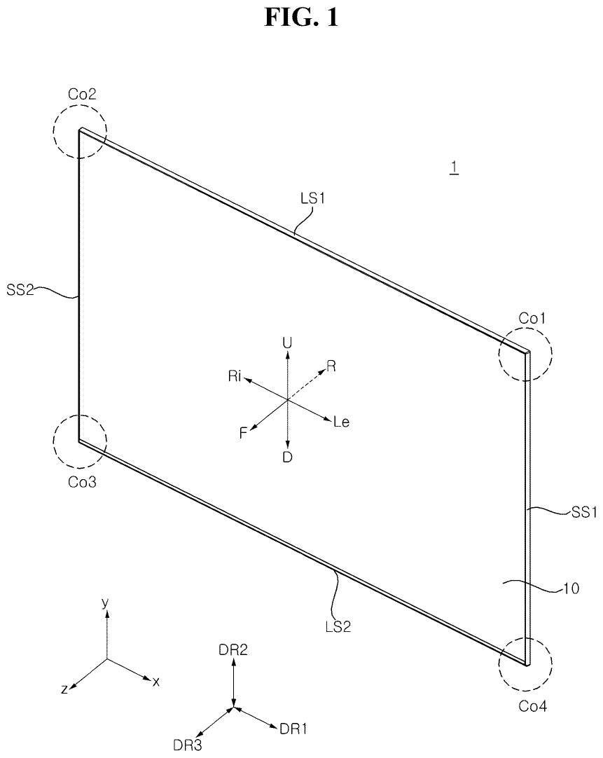

Referring to FIG. 1, the display device 1 may include a display 10. The display 10 may display an image.

The display device 1 may include a first long side LS1, a second long side LS2 opposed to the first long side LS1, a first short side SS1 adjacent to the first long side LS1 and the second long side LS2, and a second short side SS2 opposed to the first short side SS1. Although each of the first and second long sides LS1 and LS2 is illustrated and described as being longer than each of the first and second short sides SS1 and SS2 for convenience of explanation, the length of each of the first and second long sides LS1 and LS2 may be almost equal to that of each of the first and second short sides SS1 and SS2.

A direction parallel to the first and second long sides LS1 and LS2 of the display device 1 may be referred to as a lateral direction or a first direction DR1. A direction parallel to the first and second short sides SS1 and SS2 of the display device 1 may be referred to as a vertical direction or a second direction DR2. A direction perpendicular to the first and second long sides LS1 and LS2 and the first and second short sides SS1 and SS2 of the display device 1 may be referred to as a forward/backward direction or a third direction DR3.

A direction in which the display panel 10 displays an image may be referred to as forward F or z, and the opposite direction may be referred to as rearward R. The first long side LS1 may be referred to as an upper side U or y, and the second long side LS2 may be referred to as a lower side. The first short side SS1 may be referred to as a left side Le or x, and the second short side SS2 may be referred to as a right side Ri.

The first long side LS1, the second long side LS2, the first short side SS1 and the second short side SS2 may be referred to as an edge of the display device 1. The points at the first long side LS1, the second long side LS2, the first short side SS1 and the second short side SS2 meet each other may be referred to as corners.

For example, the point at which the first short side SS1 and the first long side LS1 meet each other may be referred to as a first corner Co1. The point at which the first long side LS1 and the second short side SS2 meet each other may be referred to as a second corner Co2. The point at which the second short side SS2 and the second long side LS2 meet each other may be referred to as a third corner Co3. The point at which the second long side LS2 and the first short side SS1 meet each other may be referred to as a fourth corner Co4.

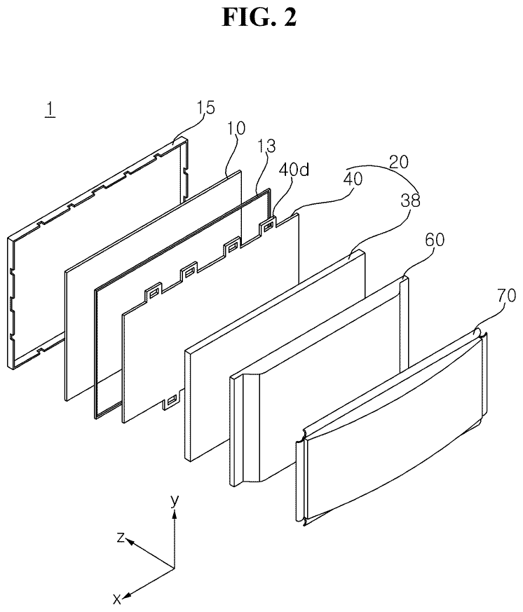

Referring to FIG. 2, the display device 1 may include the display panel 10, a print cover 15, a guide panel 13, a backlight unit 20, a frame 60 and/or a back cover 70.

The display panel 10 may define the front face of the display device 1 so as to display an image. The display panel 10 may display an image by outputting red, green or blue of each of a plurality of pixels at specific times. The display panel 10 may be divided into an active area, in which an image is displayed, and an inactive area, in which an image is not displayed. The display panel 10 may include a front substrate and a rear substrate, which face each other with a liquid crystal layer interposed therebetween. The display panel 10 may be referred to as an LCD.

The front substrate may include a plurality of pixels, each of which is composed of red, green and blue sub-pixels. The front substrate may output light corresponding to red, green or blue in response to a control signal.

The rear substrate may include switching devices. The rear substrate may switch a pixel electrode. For example, the pixel electrode may change the molecular arrangement of the liquid crystal layer in response to a control signal. The liquid crystal layer may include liquid crystal molecules. The arrangement of the liquid crystal molecules may be changed according to the voltage difference between the pixel electrode and the common electrode. The liquid crystal layer may transmit the light supplied from the backlight unit 20 to the front substrate, or may obstruct the transmission of light.

The front cover 15 may cover a portion of the front surface and the lateral surface of the display panel 10. The front cover 15 may be divided into a front cover disposed on the front surface of the display panel 10 and a lateral cover disposed on the lateral surface of the display panel 10. The front cover and the lateral cover may be separately constructed or integrally constructed. At least one of the front cover or the lateral cover may be omitted.

The guide panel 13 may surround the periphery of the display panel 10 and may cover the lateral surfaces of the display panel 10. The guide panel 13 may be coupled to the display panel 10 or may support the display panel 10. The guide panel 13 may be referred to as a “panel guide 13” or a “side frame 13”.

The backlight unit 20 may be positioned behind the display panel 10. The backlight unit 20 may include light sources. The backlight unit 20 may be positioned in the front of the frame 60, and may be coupled to the frame 60. The backlight unit 20 may be driven in a whole area driving manner or in a local area driving manner, such as local dimming driving or impulse driving. The backlight unit 20 may include an optical sheet 40 and an optical layer 38.

The optical sheet 40 may uniformly transmit the light from the light sources to the display panel 10. The optical sheet 40 may be composed of a plurality of layers. For example, the optical sheet 40 may include a prism sheet, a diffusion sheet and the like. Meanwhile, a coupler 40d of the optical sheet 40 may be coupled to the front cover 15, the frame 60 or the back cover 70.

The frame 60 may be positioned behind the backlight unit 20 so as to support the components of the display device 1. For example, components such as the backlight unit 20 and a printed circuit board (PCB), on which a plurality of electronic components are positioned, may be coupled to the frame 60. The frame 60 may include a metal such as an aluminum alloy. The frame 60 may be referred to as a “main frame” or a “module cover”.

The back cover 70 may cover the rear surface of the frame 60. The back cover 70 may be coupled to the frame 60 and/or the front cover 15. For example, the back cover 70 may be produced through injection-molding of a resin. In another embodiment, the back cover 70 may include a metal material. The back cover 70 may cover a portion of the rear side of the frame 60. For example, the back cover may cover a lower end portion of the rear side of the frame 60.

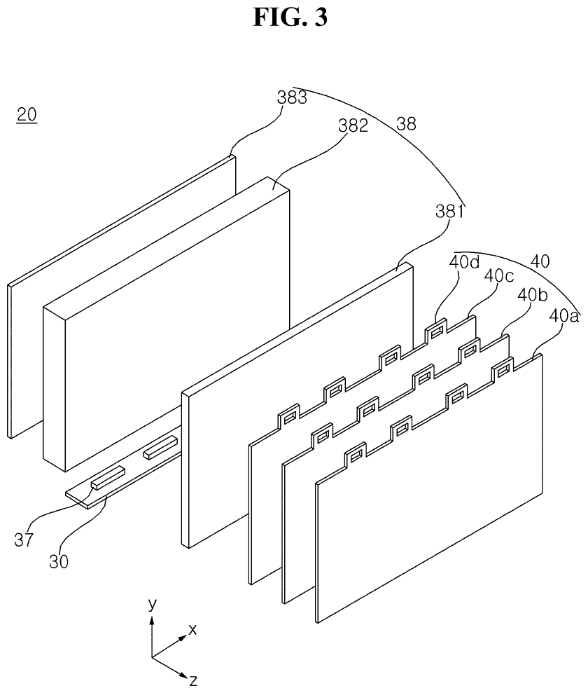

Referring to FIG. 3, the optical layer 38 may include a diffusion plate 381, a light guide plate 382 and/or a reflective sheet 383. The optical sheet 40 may be positioned in front of the optical layer 38.

The backlight unit 20 may include at least one optical source 37 configured to provide light, and a substrate 30. The optical source 37 may be referred to as an optical assembly 37, a plurality of optical sources 37, a light source 37, a light assembly 37, or a plurality of light sources 37.

The substrate 30 may extend along one side of the display panel 10, and the plurality of optical sources 37 may be arranged in the longitudinal direction of the substrate 30 so as to be spaced apart from each other. For example, the substrate 30 may extend in a right-and-left direction.

The substrate 30 may be disposed adjacent to the periphery of the light guide plate 382. For example, the substrate 30 may be disposed adjacent to the lower side of the light guide plate 382. An electrode pattern may be formed at the substrate 30 so as to connect an adaptor to the optical source 37. For example, the electrode pattern may be a carbon nanotube electrode pattern. The substrate 30 may be composed of at least one of polyethylene terephthalate (PET), glass, polycarbonate (PC) or silicon. The substrate 30 may be a printed circuit board (PCB) on which the optical source 37 is mounted.

The optical source 37 may be a light-emitting diode (LED) chip or a light-emitting diode package including at least one light-emitting diode chip. The optical source 37 may be composed of a colored LED configured to emit at least one color among red, green and blue or a white color LED. The colored LED may include at least one of a red LED, a green LED or a blue LED.

The optical source 37 may be a POB (package on board)-type LED, and the optical source 37 may be coupled to the substrate 30 through surface mount technology (SMT). For example, the length of the long side of the optical source 37 may be greater than 3 times the length of the short side of the optical source 37. For example, the length of the long side of the optical source 37 may be 7.0 mm, and the length of the short side of the optical source 27 may be 2.0 mm.

The light guide plate 382 may be disposed behind the optical sheet 40. Most of the light supplied from the optical source 37 may be transmitted to the inside of the light guide plate 382. The light guide plate 382 may reflect the light, transmitted from the optical source 37, forwards.

The reflective sheet 383 may be disposed behind the light guide plate 382. The reflective sheet 383 may reflect the light, which is supplied from the optical source 37 or reflected by the light guide plate 392, forwards. For example, the reflective sheet 383 may include metal and/or metal oxide having high reflectance, such as at least one of aluminum (Al), silver (Ag), gold (Au) or titanium dioxide (TiO2).

The diffusion plate 381 may be positioned between the light guide plate 382 and the optical sheet 40. The diffusion sheet 381 may uniformly diffuse the light forwardly reflected from the light guide plate 382.

The light sheet 40 may include at least one sheet. For example, the optical sheet 40 may include one or more prism sheets and/or one or more diffusion sheets. The plurality of sheets of the optical sheet 40 may be attached to each other or be in close contact with each other.

Specifically, the optical sheet 40 may be composed of a plurality of sheets which have different functions. For example, the optical sheet 40 may include a first optical sheet 40a, a second optical sheet 40b and a third optical sheet 40c. For example, the first diffusion sheet 40a may be a diffusion sheet, and the second optical sheet 40b and the third optical sheet 40c may be prism sheets. The diffusion sheet may prevent the light exiting from the diffusion plate 381 from being locally concentrated, thus providing more uniformly distributed light. The prism sheet may collect the light exiting from the diffusion plate 381 and may provide the light to the display panel 10. The number and/or position of the diffusion sheets and the prism sheets may be changed.

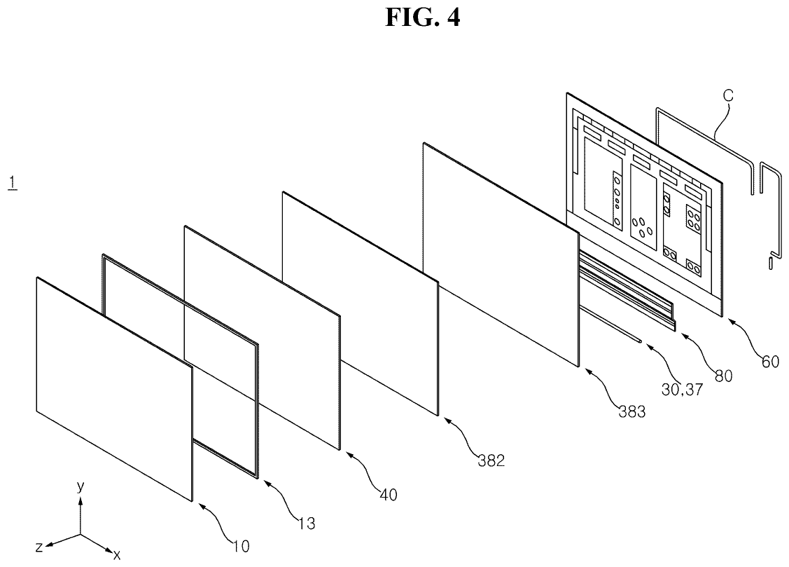

Referring to FIG. 4, the display device 1 may include a housing 80 positioned in front of the frame 60. The substrate 30 may be coupled to the housing 80. At least a portion of the housing 80 may be positioned between the frame 60 and the reflective sheet 383, and the housing 80 may be disposed adjacent to the lower side of the frame 60. The housing 80 may radiate the heat generated by the optical source 37 and/or the substrate 30. The housing 80 may be made of a material having high thermal conductivity, and may include aluminum (Al). The housing 80 may be referred to as an LED housing 80 or a heat sink 80.

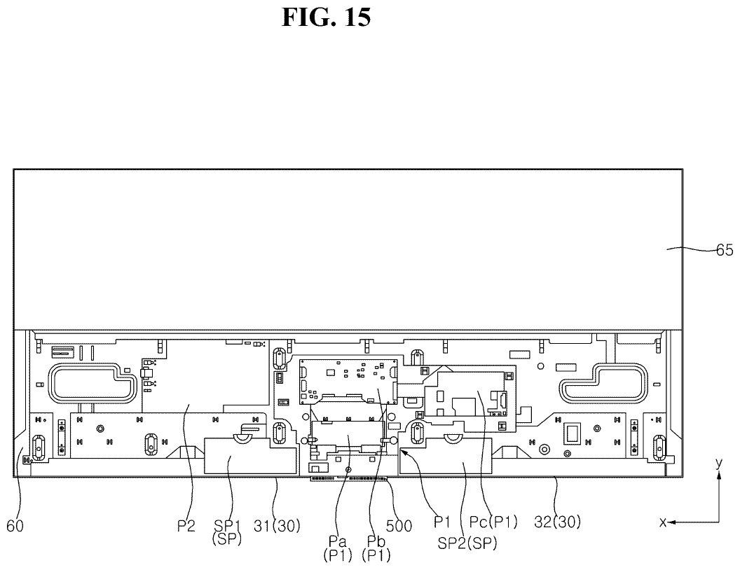

A cable C may be positioned behind the frame 60, and may connect a board P (see FIG. 15) to be described later to the substrate 30. A hole may be formed in the frame 60. In an embodiment of the present disclosure, for example, the cable C may be connected to the substrate 30 positioned in front of the frame 60 through the hole in the frame 60. In another embodiment of the present disclosure, for example, a portion of the substrate 30 may be positioned at the hole so as to be connected to the cable C. For example, the cable C may be a flexible flat cable (FFC).

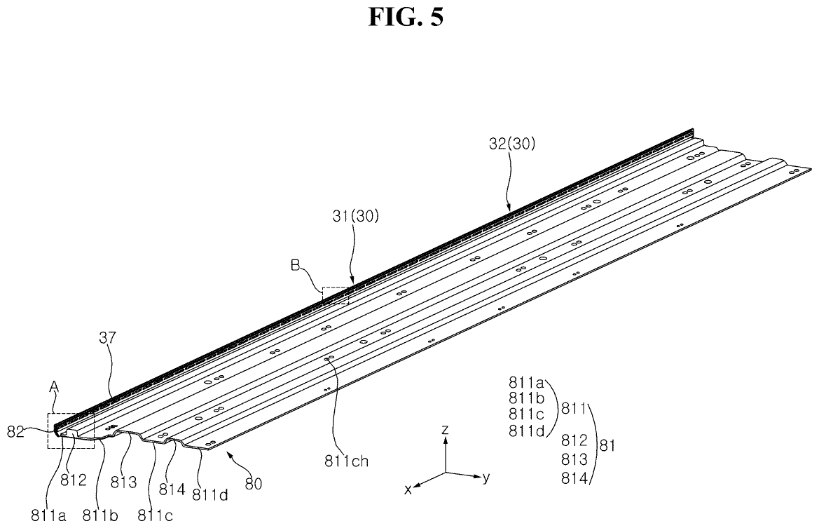

Referring to FIGS. 4 and 5 together, the housing 80 may include a rear part 81 positioned behind the display panel 10, and a side part 82 intersecting the rear part 81. The rear part 81 may be positioned in front of the frame 60. For example, the rear part 81 may be disposed between the frame 60 and the reflective sheet 383. The side part 82 may extend forwards from the lower end of the rear part 81. For example, the side part 82 may be bent forwards from the lower end of the rear part 81.

The rear part 81 may have the form of a corrugated plate overall. The rear part 81 may include a flat part 811 extending from the rear end of the side part 82, and a projecting portion 812 forwardly projecting from the flat part 811. The rear part 81 may include a first press portion 813 which projects forwards from the flat part 811 and is positioned above the projecting portion 812, and a second press portion 814 which is positioned above the first press portion 813 and projects forwards from the flat part 811.

The flat part 811 may include a first flat part 811a positioned between the side part 82 and the projecting portion 812, a second flat part 811b positioned between the projecting portion 812 and the first press portion 813, a third flat part 811c positioned between the first press portion 813 and the second press portion 814 and/or a fourth flat part 811d positioned above the second press portion 814. The first to fourth flat parts 811a, 811b, 811c and 811d may be positioned on the same plane.

The rear part 81 may include a plurality of coupling holes 811ch formed therethrough in a forward-and-backward direction, and a portion of the frame 60 may be inserted into the plurality of coupling holes 811ch. The plurality of coupling holes 811ch may be formed in the flat part 811.

The side part 82 may project forwards from the lower end of the rear part 81 and may extend in one direction lengthwise. The side part 82 may face the lower side of the light guide plate 382 and may extend along the lower side of the light guide plate 382. For example, the side part 82 may extend in a right-and-left direction. For example, the side part 82 may be orthogonal to the rear part 81.

The substrate 30 may be coupled to the side part 82. The substrate 30 may include a first substrate 31, which extends leftwards from the center of the side part 82, and a second substrate 32, which extends rightwards from the center of the side part 82. The fist substrate 31 and the second substrate 32 may be positioned in proximity to each other in a right-and-left direction.

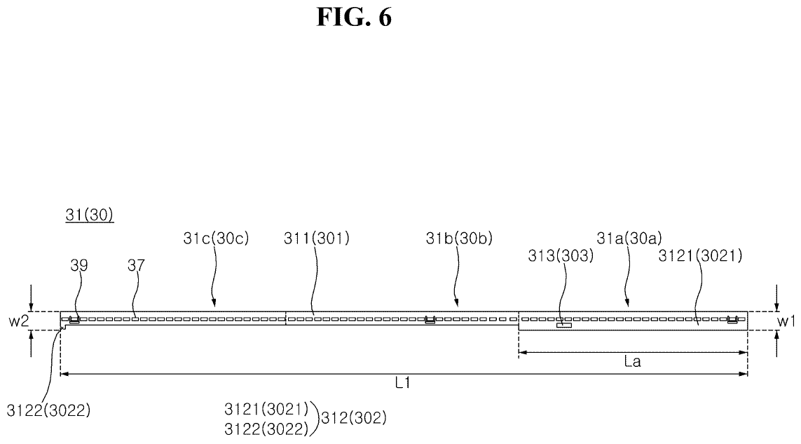

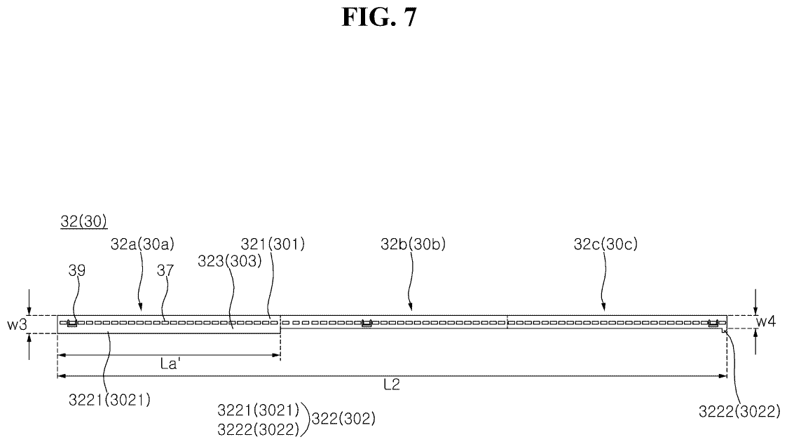

Referring to FIGS. 6 and 7, the substrate 30 may include a body 301, which extends in one direction, and an enlarged portion 302, which extends from the body 301. The enlarged portion 302 may extend in one direction perpendicular to the longitudinal direction of the body 301.

The body 301 may have the form of a thin strip overall and may extend in a right-and-left direction. The enlarged portion 302 may include an extending portion 3021 which projects forwards or backwards. The plurality of optical sources 37 may be mounted on the body 301 and may be spaced apart from each other in the longitudinal direction of the body 301.

The enlarged portion 302 may include a guide portion 3022 which projects backwards from the end of the body 301. The guide portion 3022 may catch on the rear part 81 (see FIG. 5) and may guide a location at which the substrate 30 is coupled to the side part 82.

A spacer 39 may be coupled to the body 301 and may surround the optical source 37. For example, at least a portion of the spacer 39 may be positioned between the plurality of optical sources 37 which are disposed adjacent to each other. The substrate 30 may include a plurality of spacers 39, and the plurality of spacers 39 may be spaced apart from each other in the longitudinal direction of the body 301.

The substrate 30 may include a connector 303 to which the cable C is connected.

The first substrate 31 may include a first body 311, which extends in one direction, and a first enlarge portion 312, which extends from the first body 311. The first enlarged portion 312 may extend in one direction perpendicular to the longitudinal direction of the first body 311.

The first body 311 may have the form of a thin strip overall and may extend in a right-and-left direction. The first enlarged portion 312 may include a first extending portion 3121 which projects forwards or backwards from the first body 311. The plurality of optical sources 37 may be mounted on the first body 311 and may be spaced apart from each other in the longitudinal direction of the first body 311. The first extending portion 3121 may be positioned adjacent to the right end of the first body 311 and may project backwards from the first body 311.

The first enlarged portion 312 may include a first guide portion 3122 which projects backwards from the left end of the first body 311. The first guide portion 3122 may catch on the left end of the rear part 81 (see FIG. 5) and may guide coupling of the first substrate 31 to the side part 82.

The plurality of spacers 39 may be coupled to the first body 311 and may be spaced apart from each other in the longitudinal direction of the first body 311.

The first substrate 31 may include a first part 31a, a second part 31b, and a third part 31c. Each of the first to third parts 31a, 31b and 31c may be one of segments obtained by dividing the first substrate 31. The first part 31a may extend leftwards from the right end of the first substrate 31, the third part 31c may extend rightwards from the left end of the first substrate 31, and the second part 31b may be positioned between the first part 31a and the third part 31c. For example, each of the first part 31a, the second part 31b, and the third part 31c may include the same number of optical sources 37, and the first to third parts 31a, 31b and 31c may be independently controlled.

The first extending portion 3121 may be formed at the first part 31a. For example, the first extending portion 3121 may extend backwards from a portion of the first body 311 positioned at the first part 31a. The length of the first body positioned at the first part 31a may be equal to the length of the first extending portion 3121. The length of the first part 31a may be equal to the length of the first extending portion 3121. For example, the first part 31a may have a strip shape having a width greater than the width of the second part 31b and/or the second part 31c.

The length La of the first part 31a may be substantially equal to the length of the second part 31b and/or the length of the third part 31c. For example, the length L1 of the first substrate 31 may be greater than 2 times the length La of the first part 31a but be less than 4 times the length La. For example, the length L1 of the first substrate 31 may be about 3 times the length La of the first part 31a.

A first connector 313 may be positioned at the first part 31a behind the optical source 37. The first guide portion 3122 may be formed at the third part 31c. The first guide portion 3122 may be disposed adjacent to the end of the third part 31c and may project backwards from the first body 311.

The width w1 of the first part 31a may be greater than the width W2 of the second part 31b and/or the third part 31c. The width w2 of the third part 31c may be equal to the width of the second part 31b and may be referred to as the width of the second part 31b. The width w1 of the first part 31a may mean the length of the first part 31a in a forward-and-backward direction, and the width w2 of the second part 31b and/or the third part 31c may mean the length of the second part 31b and/or the third part 31c in the forward-and-backward direction.

For example, the width w1 of the first part 31a may be greater than 1.1 times but less than 1.5 times the width w2 of the third part 31c. For example, the width w1 of the first part 31a may be about 1.3 times the width w2 of the third part 31c.

The second substrate 32 may have a shape symmetrical to the first substrate 31 in a right-and-left direction. Specifically, the second substrate 32 may include a second body 321, which extends in one direction, and a second enlarged portion 322, which extends from the second body 321. The second enlarged portion 322 may extend in one direction perpendicular to the longitudinal direction of the second body 321.

The second body 321 may have a thin strip shape overall and may extend in a right-and-left direction. The second enlarged portion 322 may include a second extending portion 3221 which projects forwards or backwards from the second body 321. The plurality of optical sources 37 may be mounted on the second body 321 and may be spaced apart from each other in the longitudinal direction of the second body 321. The second extending portion 3221 may be disposed adjacent to the left end of the second body 321 and may project backwards from the second body 321.

The second enlarged portion 322 may include a second guide portion 3222 which projects backwards from the left end of the second body 321. The second guide portion 3222 may catch on the right end of the rear part 81 (see FIG. 5) and may guide a location at which the second substrate 32 is coupled to the side part 82.

The plurality of spacers 39 may be coupled to the second body 321 and may be spaced apart from each other in the longitudinal direction of the second body 321.

The second substrate 32 may include a first part 32a, a second part 32b, and a third part 32c. Each of the first to third parts 32a, 32b and 32c may be one of segments obtained by dividing the second substrate 32 in the longitudinal direction of the second substrate 32. The first part 32a may extend rightwards from the left end of the second substrate 32, the third part 32c may extend leftwards from the right end of the second substrate 32, and the second part 32b may be positioned between the first part 32a and the third part 32c.

The second extending portion 3221 may be formed at the first part 32a. For example, the second extending portion 3221 may extend backwards from a portion of the second body 321 positioned at the first part 32a. The length of the second body 321 positioned at the first part 32a may be equal to the length of the second extending portion 3221. The length of the first part 32a may be equal to the length of the second extending portion 3221. For example, the first part 32a may have a strip shape having a width greater than the width of the second part 32b and/or the third part 32c.

The length La′ of the first part 32a may be substantially equal to the length of the second part 32b and/or the length of the third part 32c. For example, the length L2 of the second substrate 32 may be greater than 2 times but less than 4 times the length La′ of the first part 32a. For example, the length L2 of the second substrate 32 may be about 3 times the length La′ of the first part 32a.

A second connector 323 may be positioned at the first part 32a behind the optical source 37. The second guide portion 3222 may be formed at the third part 32c. The second guide portion 3222 may be disposed adjacent to the end of the third part 32c and may project backwards from the second body 321.

The width w3 of the first part 32a may be greater than the width w4 of the second part 32b and/or the third part 32c. The width w4 of the third part 32c may be equal to the width of the second part 32b and may be referred to as the width of the second part 32b. The width w3 of the first part 32a may mean the length of the first part 32a in a forward-and-backward direction, and the width w4 of the second part 32b and/or the third part 32c may mean the length of the second part 32b and/or the third part 32c in the forward-and-backward direction. The width w4 of the third part 32c may mean the width of the second body 321.

For example, the width w3 of the first part 32a may be greater than 1.1 times but less than 1.5 times the width w4 of the third part 32c. For example, the width w3 of the first part 32a may be about 1.3 times the width w4 of the third part 32c.

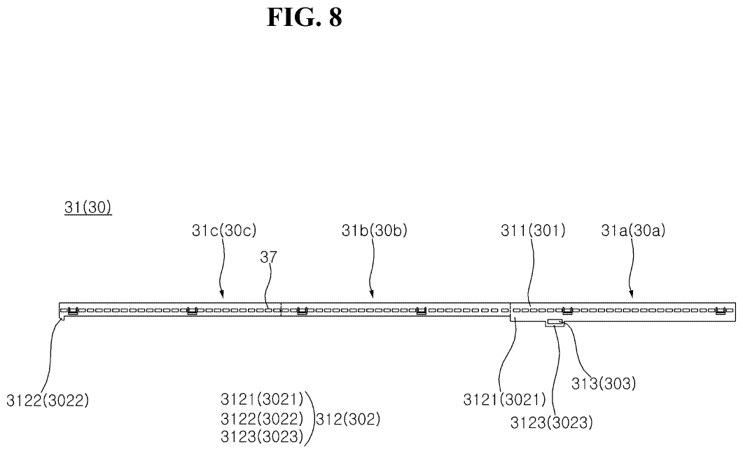

Referring to FIG. 8, in another embodiment of the present disclosure, the substrate 30 may include the enlarged portion 302 which projects backwards from the body 301, and the enlarged portion 302 may include the extending portion 3021, which projects backwards from the body 301, and a mount part 3023, which projects backwards from the extending portion 3021. The mount part 3023 may be formed at the first part 30a. The connector 303 may be positioned at the mount part 3023 behind the plurality of optical sources 37.

For example, the first substrate 31 may include the first enlarged portion 312 which projects backwards from the first body 311. The first enlarged portion 312 may include the first extending portion 3121, which projects backwards from the first body 311, and a first mount part 3123, which projects backwards from the first extending portion 3121. The first mount part 3123 may be formed at the first part 31a. The first connector 313 may be positioned at the first mount part 3123 behind the plurality of optical sources 37. For example, the second substrate 32 may have a shape symmetrical to the first substrate 31 in a right-and-left direction.

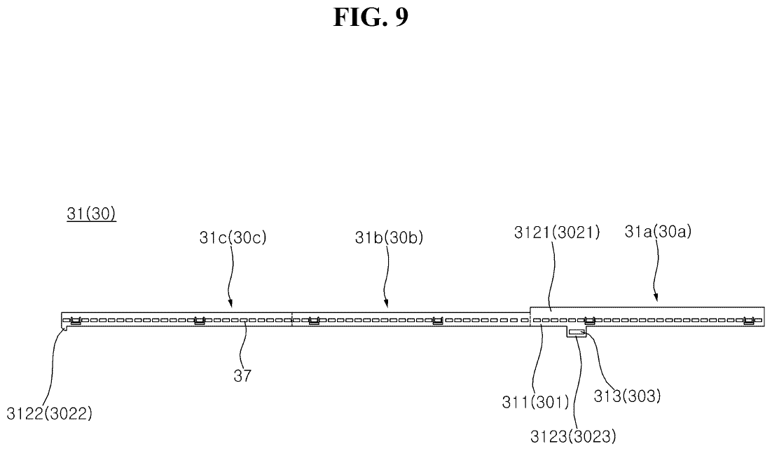

Referring to FIG. 9, in still another embodiment of the present disclosure, the substrate 30 may include the enlarged portion 302 which projects forwards or backwards from the body 301. The enlarged portion 302 may include the extending portion 3021, which projects forwards from the body 301, and the mount part 3023, which projects backwards from the body 301. The extending portion 3021 may be formed at the first part 30a, and the mount part 3023 may be formed at the first part 30a. The connector 303 may be positioned at the mount part 3023 behind the plurality of optical sources 37.

For example, the first substrate 31 may include the first enlarged portion 312 which projects forwards or backwards from the first body 311. The first enlarged portion 312 may include the first extending portion 3121, which projects forwards from the first body 311, and the first mount part 3123, which projects backwards from the first body 311. The first extending portion 3121 may be formed at the first part 31a, and the first mount part 3123 may be formed at the first part 31a. The first connector 313 may be positioned at the first mount part 3123 behind the plurality of optical sources 37.

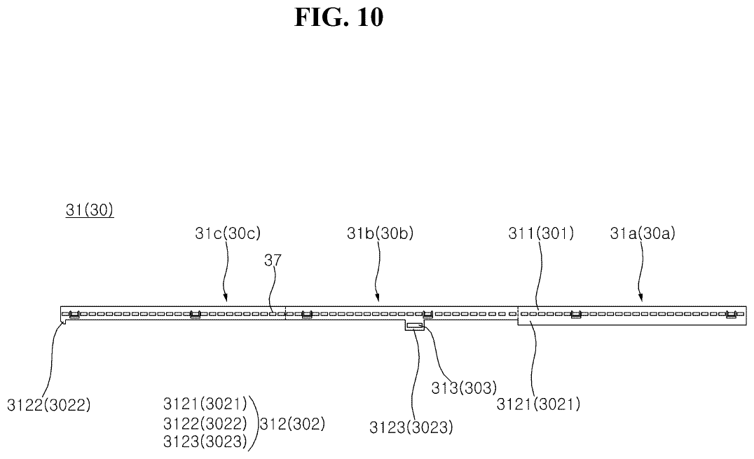

Referring to FIG. 10, in yet another embodiment of the present disclosure, the substrate 30 may include the enlarged portion 302 which projects backwards from the body 301. The enlarged portion 302 may include the extending portion 3021, which projects backwards from the body 301, and the mount part 3023, which projects backwards from the body 301. The mount part 3023 may be formed at the second part 30b or the third part 30c. The connector 303 may be positioned at the mount part 3023 behind the plurality of optical sources 37. The rear end of the mount part 3023 may be positioned behind the rear end of the extending portion 3021.

For example, the first substrate 31 may include the first enlarged portion 312 which projects backwards from the first body 311. The first enlarged portion 312 may include the first extending portion 3121, which projects backwards from the first body 311, and the first mount part 3123, which projects backwards from the first body 311. The first mount part 3123 may be formed at the second part 31b or the third part 31c. The first connector 313 may be positioned at the first mount part 3123 behind the plurality of optical sources 37. The rear end of the first mount part 3123 may be positioned behind the rear end of the first extending portion 3121. For example, the second substrate 32 may have a shape symmetrical to the first substrate 31 in a right-and-left direction.

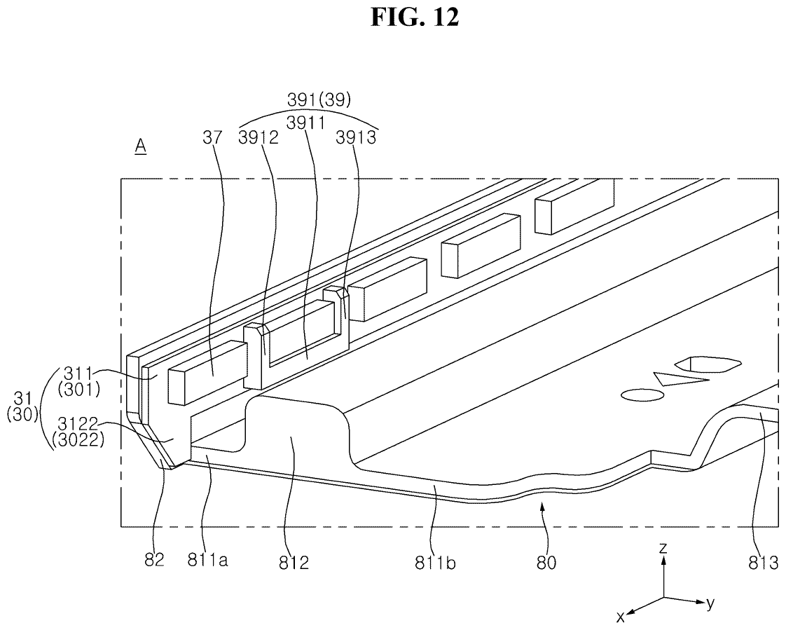

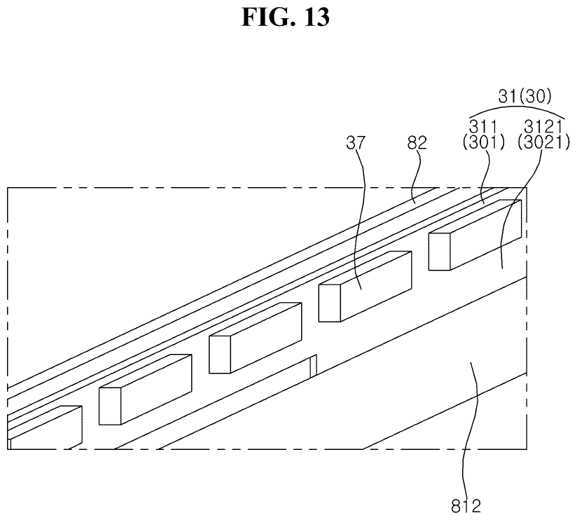

Referring to FIGS. 5 and 11 to 13, the first body 311 may be coupled to the upper surface of the side part 82 of the housing 80, and the rear end of the first body 311 may be spaced apart from the rear part 81. The front end of the projecting portion 812 may be positioned behind the front ends of the plurality of optical sources 37.

The first guide portion 3122 may be coupled to the side part 81 and may catch on the left end of the rear part 81. The first guide portion 3122 may be referred to as a first catch portion or a first hook.

The spacer 39 may include a base 391, and at least a portion of the base 391 may be positioned between adjacent optical sources 37. The base 391 may have a U shape overall. The spacer 39 may be referred to as a pad 39 or a U pad 39.

The base 391 may include a first part 3911, which extends in the longitudinal direction of the first body 311, a second part 3912, which extends forwards from the left end of the first part 3911, and a third part 3913, which extends forwards from the right end of the first part 3911. The first part 3911 may be positioned behind the optical source 37, and the second part 3912 may be positioned between adjacent optical sources 37. The third part 3913 may be spaced rightwards apart from the second part 3912. At least one optical source 37 may be disposed between the second part 3912 and the third part 3913. The distance between the upper surface of the substrate 30 and the upper end of the base 391 may be greater than the distance between the upper surface of the substrate 30 and the upper end of the optical source 37.

Consequently, the spacer 39 is able to protect the upper surface of the optical source 37 from external impact.

The first extending portion 3121 may extend toward the rear part 81 from the first body 311. For example, the first extending portion 3121 may be in contact with the front surface of the rear part 81. For example, the extending portion 3121 may extend toward the first flat part 811a and may be in contact with the first flat part 811a.

Although not illustrated in the drawings, the second extending portion 3221 (see FIG. 7) may extend toward the rear part 81 from the second body 321. For example, the second extending portion 3221 (see FIG. 7) may be in contact with the front surface of the rear part 81. For example, the second extending portion 3221 (see FIG. 7) may extend toward the first flat part 811a and may be in contact with the first flat part 811a.

The first extending portion 3121 may be positioned in the center of the side part 82 in a right-and-left direction, and the second extending portion 3221 (see FIG. 7) may be positioned in the center of the side part 82 in the right-and-left direction. The width of the substrate 30 in the center of the side part 82 may be greater than the width of the substrate 30 at the right and left ends of the side part 82. Consequently, it is possible to improve heat dissipation performance at the center portion of the side part 82. Here, the width of the substrate 30 may mean the length of the substrate 30 in a forward-and-backward direction

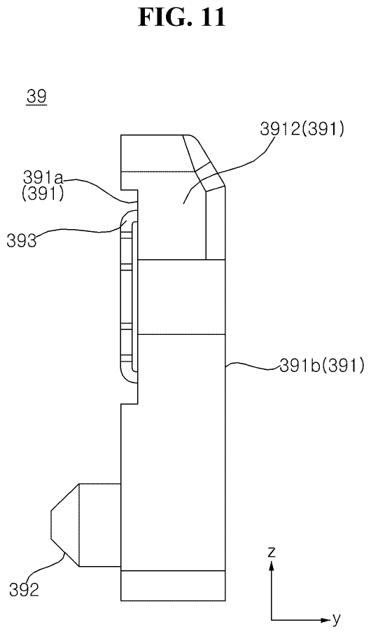

Referring to FIGS. 11, 13 and 14, the spacer 39 may include a protrusion 392 which projects toward the substrate 30 from the base 391. For example, the protrusion 392 may projects from the lower surface of the base 391. The substrate 30 may be provided with a hole 30h which is formed the substrate in an up-and-down direction, and the protrusion 392 may be inserted into the hole 30h. Accordingly, the spacer 39 may be coupled to the substrate 30. The protrusion 392 may include a plurality of protrusions 3911 which are spaced apart from each other. For example, the spacer 39 may include two protrusions 392 which are positioned at a portion at which the first part 3911 meets the second part 2912 and at a portion at which the first part meets the third part 3913.

The spacer 39 may include a recess 391a which is depressed from the surface of the base that faces the substrate 30. The recess 391a may be depressed upwards from the lower surface of the base 391. The spacer 39 may include a shock absorber capable of absorbing shock, and the shock absorber 393 may be positioned in the recess 391a. The shock absorber 392 may have a bent band shape overall.

The projecting portion of the rear part 81 may support the rear surface of the optical layer 38. The reflective sheet 383 may define the rear surface of the optical layer 38, and the projecting portion 812 may support the reflective sheet 383. A sheet 382a may be positioned between the reflective sheet 383 and the projecting portion 812. For example, the sheet 383a may serve to protect the reflective sheet 383 and may be made of a material having a coefficient of friction less than the projecting portion 812. Alternatively, the sheet 383a may be an adhesive member capable of coupling the reflective sheet 383 to the projecting portion 812.

The distance between the substrate 30 and the supporting surface 391b of the base 391 may be greater than the distance between the substrate 30 and the upper end of the optical source 37. The supporting surface 391b of the base 391 may mean the upper surface of the base 391. The lower side of the optical layer 38 may be disposed adjacent to the supporting surface 391b of the base 391. For example, the lower side of the optical layer 38 may be in contact with the supporting surface 391b of the base 391 and may be supported by the supporting surface 391b. Consequently, it is possible to prevent collision between the optical source 37 and the optical layer 38.

An adhesive member AD may be positioned between the substrate 30 and the side part 82 so as to couple the substrate 30 to the side part 82.

Referring to FIGS. 5 and 15, a first board P1 may be positioned behind the frame 60 and may be coupled to the frame 60. The first board P1 may be positioned at a lower portion of the frame 60 in an up-and-down direction. The first board P1 may include a plurality of boards Pa, Pb and Pc. For example, the first board P1 may be a board assembly in which the plurality of boards Pa, Pb and Pc are intercoupled. For example, the first board P1 may include a T-CON board Pa, an AMP board (amplifier board) Pb, and a wireless communication board Pc. The first board P1 may be positioned in the center of the frame 60 in a right-and-left direction.

A second board P2 may be coupled to the frame 60 from the rear of the frame 60. The second board P2 may be positioned at a lower portion of the frame 60 in an up-and-down direction. The second board P2 may be positioned at the left side of the first board P1. Although not illustrated in the drawings, the cable C (see FIG. 4) may connect the first board P1 to the substrate 30. For example, the second board P2 may be a power board.

The display device 1 may include a communication unit 500 capable of performing communication with an exterior device. The communication unit 500 may transmit and/or receive a signal to and/or from an exterior device in a wireless communication manner. For example, the communication unit 500 may perform wireless communication with a set-top box. Alternatively, the communication unit 500 may perform communication with a remote controller via infrared light. The communication unit 500 may also be referred to as an antenna, a wireless transceiver 500, an infrared transceiver 500, or an IR receiver 500.

The communication unit 500 may be positioned in the center of the lower side of the display device 1. The lower end of the first board P1 may be disposed adjacent to the center of the lower side of the display device.

Accordingly, heat generation at the center portion of the lower side may increase.

The extending portion 3021 of the substrate 30 may be positioned at the center portion of the lower side of the display device 1. Specifically, the first extending portion 3121 of the first board 31 may be positioned at the right end of the first substrate 31 and may be positioned in the center of the lower side of the display device 1. The second extending portion 3221 of the second substrate 32 positioned at the right side of the first substrate 21 may be positioned at the left end of the second substrate 32 and may be positioned in the center of the lower side of the display device 1.

Accordingly, it is possible to improve heat dissipation performance at the center portion of the lower side of the display device and to prevent excessive increase of temperature of the center portion of the lower side of the display device.

The display device 1 may include a speaker positioned at the rear side of the frame 60. The speaker SP may include a first speaker SP1 and a second speaker SP2 spaced apart from the first speaker SP1. The first speaker SP1 may be coupled to the frame 60 at the left side of the first board P1, and the second speaker SP2 may be coupled to the frame 60 at the right side of the first board P1.

A rear plate 65 may cover a portion of the frame 60 from the rear of the frame 60. The rear plate 65 may cover a portion of the upper side of the frame 60. The rear plate 65 may the form of a flat plate overall and may be exposed backwards. Although not illustrated in the drawings, a back cover 70 may be positioned below the rear plate 65 so as to cover the remaining portion of the frame 60 which is not covered by the rear plate 65.

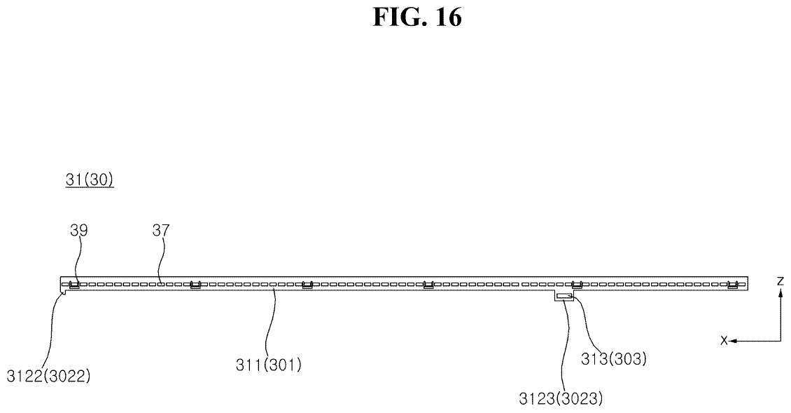

Referring to FIG. 16, the substrate 30 may include the body 301, which extends in one direction, and the mount part 3023, which projects backwards from the body 301. The connector 303 may be positioned at the mount part 3023. The plurality of optical sources 37 may be arranged in a line in the longitudinal direction of the body 301. The plurality of optical sources 37 may be arranged at regular distances. The spacer 39 may be coupled to the board 30 and may surround the side surface and the rear surface of each of the optical sources 37. The guide portion 3022 may project backwards from one end of the body 301. The mount part 3023 may be positioned closer to the other end of the body 301 opposite to the one end of the body 301.

For example, the substrate 30 may include the first substrate 31 and the second substrate 32 adjacent to each other. The first substrate 31 may be coupled to the left side of the side part 82 (see FIG. 5), and the second substrate 32 may be coupled to the right side of the first substrate 31. For example, the first substrate 31 may include 78 optical sources 37, which are spaced apart from each other in a right-and-left direction, and 6 spacers 39, which are spaced apart from each other in a right-and-left direction. The second substrate 32 may have a shape symmetrical to the first substrate 31 in a right-and-left direction. For example, the display device 1 having a size of 55 inches or 65 inches may include the substrate 40 composed of two bars. The two bars may mean the first substrate 31 and the second substrate 32.

The first substrate 31 may include the first body 311, which extends in one direction, and the first mount part 3123, which projects backwards from the first body 311. The first substrate 31 may include the first guide portion 3122 which projects backwards from the left end of the first body 311. The first mount part 3123 may be disposed so as to be spaced apart from the left end or the right end of the first body 311. The distance between the first mount part 3123 and the left end of the first body 311 may be greater than the distance between the first mount part 3123 and the right end of the first body 311. In other words, the first mount part 3123 may project backwards from an arbitrary point between the left end and the right end of the first body 311, and the first mount part 3123 may project backwards from the first body 311 close to the right end of the first body 311.

The first connector 313 may be positioned at the first mount part 3123. The plurality of optical sources 37 may be arranged in a line in the longitudinal direction of the first body 311. The plurality of optical sources 37 may be arranged at regular distances. The spacer 39 may be coupled to the first substrate 31 and may surround the side surface and the rear surface of the optical source 37. The second substrate 32 may have a shape symmetrical to the first substrate 31 in a right-and-left direction.

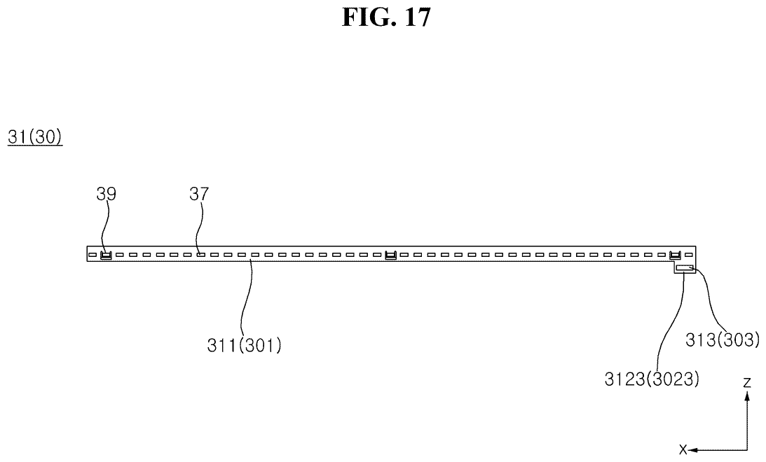

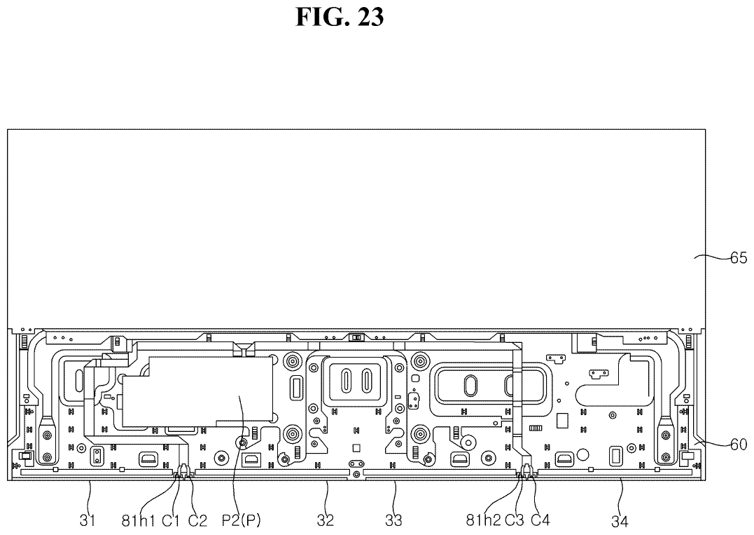

Referring to FIG. 17, the substrate 30 according to another embodiment of the present disclosure may be composed of four substrates which are disposed adjacent to each other in a right-and-left direction. For example, the first substrate 31 may include 45 optical sources 37, which are spaced apart from each other in a right-and-left direction, and 3 spacers, which are spaced apart from each other in the right-and-left direction. For example, the display device 1 having a size of 75 inches may include the substrate 30 composed of four bars. The four bars may mean a first substrate 31, a second substrate 32 (see FIG. 23), a third substrate 23 (see FIG. 23), and a fourth substrate 34 (see FIG. 23).

The first substrate 31 may include the first body 311, which extends in one direction, and the first mount part 3123, which projects backwards from the first body 311. The first mount part 3123 may project backwards from the right end of the first body 311. The first connector 313 may be positioned at the first mount part 3123. The plurality of optical sources 37 may be arranged in a line in the longitudinal direction of the first body 311. The plurality of optical sources 37 may be arranged at regular distances. The spacer 39 may be coupled to the first substrate 31 and may surround the side surface and the rear surface of each of the optical sources 37.

Referring to FIG. 23, the substrate 30 may include the first substrate 31, the second substrate 32, the third substrate 33, and the fourth substrate 34. The first substrate 31 may extend rightwards from the left end of the side part 82 (see FIG. 5), and the second substrate 32 may be positioned at the right side of the first substrate 31 and may face the first substrate 31. The third substrate 33 may be disposed on the right side of the second substrate 32 and may face the second substrate 32, and the fourth substrate 34 may be disposed on the right side of the third substrate and may face the third substrate 33. The third substrate 33 may have the same shape as the first substrate 31, and each of the second substrate 32 and the fourth substrate 34 may have a shape symmetrical to the first substrate 31 in a right-and-left direction.

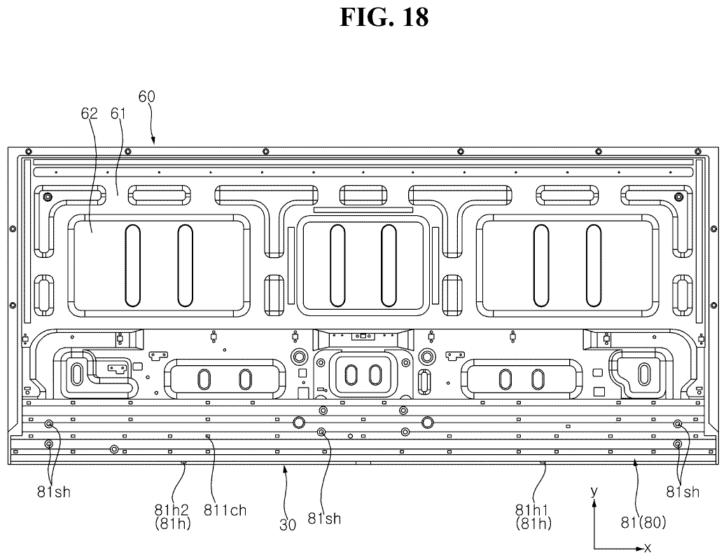

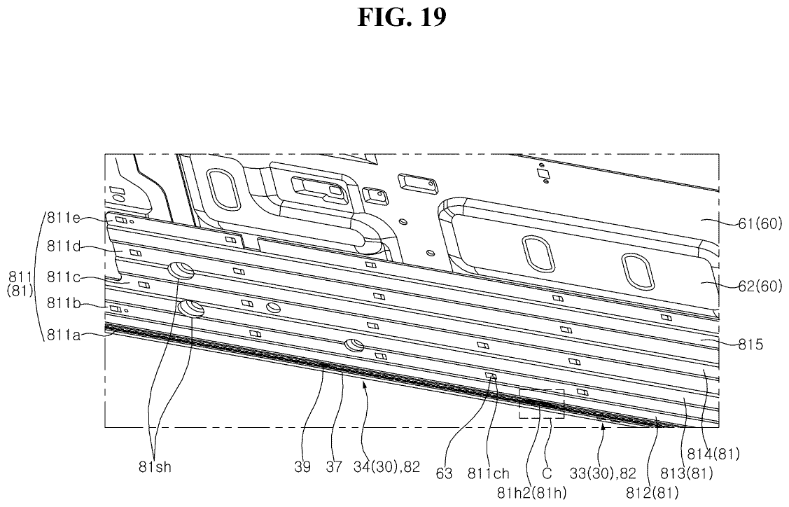

Referring to FIGS. 18 and 19, the frame 60 may include a flat plate portion 61 and a forming portion 62 which projects forwards from the flat plate portion 61. The forming portion 62 may include a plurality of forming portions 62 which are spaced apart from each other and have different sizes. Consequently, it is possible to increase bending stiffness and/or torsional stiffness.

The housing 80 may be positioned in front of the frame 60 and may be coupled to the frame 60. For example, the housing 80 may be coupled to the frame 60 through caulking. The frame 60 may include an insert portion 63, and the insert portion 63 may be inserted into the coupling hole 811ch in the rear part 81. The insert portion 63 may project forwards from the flat plate portion 61 and may include a plurality of insert portions.

The housing 80 may include a plurality of stand holes 81sh which are formed through the rear part 81 in a forward-and-backward direction. The frame 60 may include a plurality of through holes (not shown) which are formed therethrough so as to correspond to the stand holes 81sh. A PEM nut may be positioned in each of the stand holes 81sh. Although not illustrated in the drawings, a stand (not shown) may be coupled to the PEM nut positioned in the stand hole 81sh. For example, the plurality of stand holes 81sh may include a pair of stand holes 81sh, which are disposed adjacent to the left end of the rear part 81, and a pair of stand holes 81sh, which are disposed adjacent to the right end of the rear part 81. For example, the plurality of stand holes 82sh may be disposed in the center portion of the rear part 81.

The upper end of the rear part 81 may be disposed adjacent to the forming portion 62. The rear part 81 may include a third press portion 815 which projects forwards from the flat part 811, and the third press portion 815 may be positioned above the fourth flat part 811d. The flat part 811 may include a fifth flat part 811e positioned above the third press portion 815. For example, the fifth flat part 811e may be positioned on the same plane as the first to fourth flat parts 811a, 811b, 811c and 811d. For example, the third press portion 815 may be positioned on the same plane as the projecting portion 812, the first press portion 813 and/or the second press portion 814.

The rear part 81 may include an opening 81h which is disposed adjacent to the side part 82 and is formed through the rear part 81 in a forward-and-backward direction. For example, the opening 81h may be positioned at the first flat part 811a. The opening 81h may include a plurality of openings 81h1 and 81h2 which are spaced apart from each other in a right-and-left direction. For example, two openings 81h1 and 81h2 may be formed in the rear part 81. The first opening 81h1 may be positioned at the left portion of the rear part 81, and the second opening 81h2 may be spaced rightwards apart from the first opening 81h1. Accordingly, heat dissipation performance of the display device 1 around the opening 81h may be lowered.

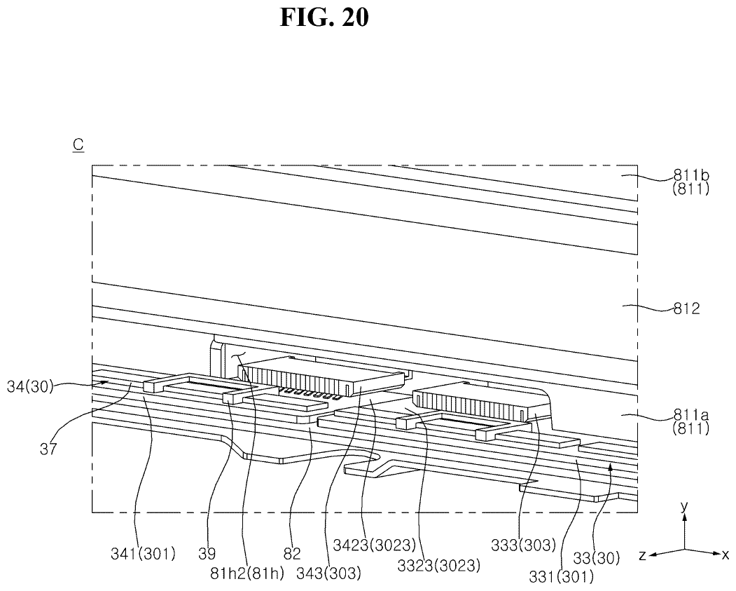

Referring to FIGS. 19 and 20, the third substrate 33 may include a third body 331 which extends in a right-and-left direction, and a third mount part 3323 which projects backwards from the right end of the third body 331. A third connector 333 may be disposed on the third mount part 3323. The fourth substrate 34 may include a fourth body 341, which extends in a right-and-left direction, and a fourth mount part 3423, which projects backwards from the right end of the fourth body 341. A fourth connector 343 may be disposed on the third mount part 3423.

The second opening 81h2 may be formed in the rear part 81 and may be disposed adjacent to the side part 82. The second opening 81h2 may be formed in the first flat part 811a.

The second opening 81h2 may have a quadrilateral hole shape overall. The upper boundary of the second opening 81h2 may be positioned at the first flat part 811a. The second opening 81h2 may be positioned below the projecting portion 812 and may be disposed so as to be spaced downwards apart from the projecting portion 812.

The mount part 3023 of the substrate 30 may be positioned in the second opening 81h2. The body 301 may be positioned in front of the first flat part 811a, and the mount part 3023 may project backwards from the first flat part 811a through the second opening 81h2. The connector 303 may be positioned in the second opening 81h2. The rear end of the body 301 may be in contact with the rear part 81. For example, the rear end of the body 301 may be in contact with the first flat part. 811a.

At least a portion of the connector 303 may be positioned behind the first flat part 811a. The height of the second opening 81h2 may be higher than the height of the connector 303. The height of the second opening 81h2 may mean the length of the second opening 81h2 in an up-and-down direction, and the height of the connector 303 may mean the length of the connector 303 in the up-and-down direction. The height of the second opening 81h2 may be greater than the sum of the height of the connector 303 and the thickness of the substrate 30.

The width of the second opening 81h2 may be greater than the width of the connector 303. The width of the second opening 81h2 may mean the length of the second opening 81h2 in a right-and-left direction, and the width of the connector 303 may mean the length of the connector 303 in a right-and-left direction. The height of the connector 303 may be less than the length of the connector 303 in a forward-and-backward direction.

Consequently, the mount part 3023 and the connector 303 may be positioned in the second opening 81h2.

Although not illustrated in the drawings, the description of the second opening 81h2 may also be applied to the first opening 81h1 (see FIG. 18).

For example, the third mount part 3323 and the fourth mount part 3423 may be positioned in the second opening 81h2. The third body 331 and the fourth body 341 may be positioned in front of the first flat part 811a, and the third mount part 3323 and the fourth mount part 3423 may project backwards from the first flat part 811a through the second opening 81h2. The length of the second opening in a right-and-left direction may be equal to or greater than the sum of the length of the third mount part 3323 in a right-and-left direction and the length of the fourth mount part 3423 in the right-and-left direction.

For example, the first mount part 3123 and the second mount part 3223 may be positioned in the first opening 81h1. The first body 311 and the second body 321 may be positioned in front of the first flat part 811a, and the first mount part 3123 and the second mount part 3223 may project backward from the first flat part 811a through the first opening 81h1. The length of the first opening 81h1 in a right-and-left direction may be equal to or greater than the sum of the length of the first mount part 3123 in the right-and-left direction and the length of the second mount part 3223 in the right-and-left direction.

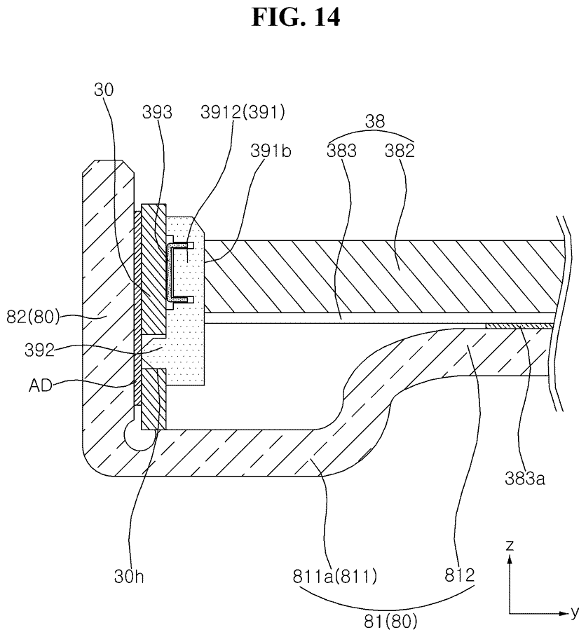

The spacer 39 may overlap the opening 81h in a right-and-left direction. The spacer 39 may overlap the connector 303 in the right-and-left direction. The hole 30h (see FIG. 14) in the substrate into which the protrusion 392 of the spacer 39 is inserted may be positioned around the opening 81h. The thermal conductivity of the spacer 39 may be lower than the substrate 30. For example, the spacer 39 may be made of a resin or silicone material through injection molding.

Accordingly, heat dissipation performance of the display device 1 around the connector may be lowered.

For example, one of the plurality of spacers 39 may be positioned in front of the third connector 333, and a hole (not shown) to which the spacer 39 is coupled may be formed in the third substrate 33.

For example, one of the plurality of spacers 39 may be positioned in front of the fourth connector 343, and a hole (not shown) to which the spacer 39 is coupled to may be formed in the fourth substrate 34.

The frame 60 may include a second through hole 60h2 which is formed through the frame 60 in a forward-and-backward direction so as to correspond to the second opening 81h2. The second through hole 60h2 may overlap the second opening 81h2 in the forward-and-backward direction. The second through hole 60h2 may have a quadrilateral hole shape overall. The size of the second through hole 60h2 may be larger than the size of the second opening 81h2.

The third mount part 3323 and the fourth mount part 3423 may be positioned in the second through hole 60h2 and may project backwards from the first flat part 811a through the second opening 81h2 and the second through hole 60h2. The cable 343 may include a third cable C3 connected to the third connector 333

The cable C may have a thin film shape. For example, the cable C may be a flexible flat cable (FFC). The cable C may include a third cable C3 connected to the third connector 333 and a fourth cable C4 connected to the fourth connector 343. The cable C may be disposed adjacent to the rear side of the frame 60.

The cable C may be connected to the connector 303 in a horizontal direction. Specifically, the cable C may be coupled to the connector 303 to the front side from the rear side of the connector 303. In other words, the cable C may be coupled to the connector 303 in a forward-and-backward direction.

The connector 303 may include an insert groove 303g which is depressed forwards from the rear end of the connector 303, and the end of the cable C may be inserted into the insert groove 303g and then be connected to the connector 303.

Accordingly, even when the cable C is disposed close to the rear side of the frame 60, it is possible to easily connect the cable C to the connector 303.

For example, the third connector 333 may include a third insert groove 333g which is depressed forwards from the rear end of the connector 330, and the end of the third cable C3 may be inserted into the third insert groove 333g. The height h3 of the third connector 333, which means the distance between the third substrate 33 and the upper end of the third connector 333, may be less than the length d3 of the third connector 333 in a forward-and-backward direction.

Consequently, it is possible to minimize the height of the portion of the third connector 333 that projects upwards from the third mount part 3323 while assuring a space sufficient to receive the third cable C3 therein. Therefore, the length of the second opening 81h2 in an up-and-down direction may be minimized.

For example, the fourth connector 343 may include a fourth insert groove 343g which is depressed forwards from the rear end of the fourth connector 343, and the end of the fourth cable C4 may be inserted into the fourth insert groove 343g. The height h4 of the fourth connector 343, which means the distance between the fourth substrate 34 and the upper end of the fourth connector 343, may be less than the length d4 of the fourth connector 343 in a forward-and-backward direction.

Consequently, it is possible to minimize the height of the portion of the fourth connector 343 that projects upwards from the fourth mount part 3423 while assuring a space sufficient to receive the fourth cable C4 therein. Therefore, the length of the second opening 81h2 in an up-and-down direction may be minimized.

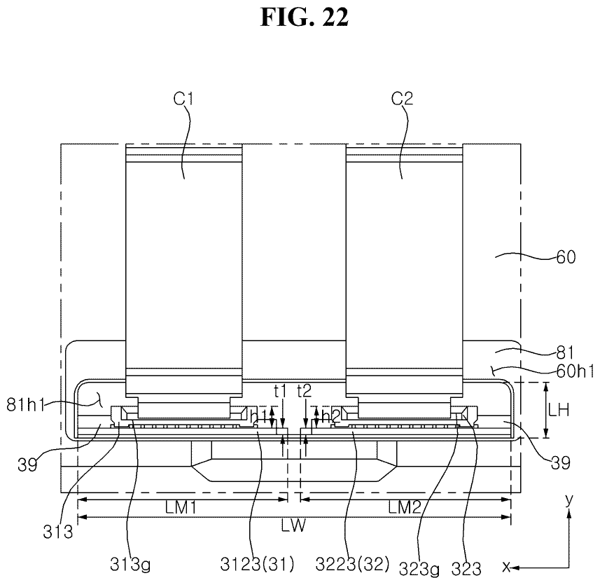

Referring to FIG. 22, the frame 60 may include a first through hole 60h1 which is formed through the frame 60 in a forward-and-backward direction so as to correspond to the first opening 81h1. The first through hole 60h1 may overlap the first opening 81h1 in a forward-and-backward direction. The first through hole 60h1 may have a quadrilateral hole shape overall and may have a surface area larger than the first opening 81h1.

The first mount part 3123 of the first substrate 31 may project backwards from the rear part 81 through the first opening 81h1 and the first through hole 60h1. The lower end of the first mount part 3123 may be in contact with the lower boundary of the first opening 81h1 and/or the first through hole 61h1.

The cable C may include a first cable C1 connected to the first connector 313. The first cable C1 may be coupled to the first connector 313 in a horizontal direction. Specifically, the first cable C1 may be coupled to the first connector 313 toward the front side from the rear side of the first connector 313. In other words, the first cable C1 may be coupled to the first connector 313 in a forward-and-backward direction. The first cable C1 may be bent upwards at the rear end of the first connector 313.

The first connector 313 may include a first insert groove 313g which is depressed forwards from the rear end of the first connector 313, and the end of the first cable C1 may be inserted into the first insert groove 313g. The length of the first insert groove 313g in a right-and-left direction may be greater than the length of the first insert groove 313g in an up-and-down direction. The length of the first connector 313 in a forward-and-backward direction may be greater than the height h1 of the first connector 313. The height h1 of the first connector 313 may mean the distance between the first mount part 3123 and the upper end of the first connector 313.

The second mount part 3223 of the second substrate 32 may project backwards from the rear part 81 through the first opening 81h1 and the first through hole 60h1. The lower end of the second mount part 3223 may be in contact with the lower boundary of the first opening 81h1 and/or the first through hole 61h1.

The cable C may include a second cable C2 connected to the second connector 323. The second cable C2 may be coupled to the second connector 323 in a horizontal direction. Specifically, the second cable C2 may be coupled to the second connector 323 to the front side from the rear side of the second connector 323. In other words, the second cable C2 may be coupled to the second connector 323 in a forward-and-backward direction. The second cable C2 may be bent upwards at the rear end of the second connector 323.

The second connector 323 may include a second insert groove 323g which is depressed forwards from the rear end of the second connector 323, and the end of the second cable C2 may be inserted into the second insert groove 323g. The length of the second insert groove 323g in a right-and-left direction may be greater than the length of the second insert groove 323g in an up-and-down direction. The length of the second connector 323 in a forward-and-backward direction may be greater than the height h2 of the second connector 323. The height h2 of the second connector 323 may mean the distance between the second mount part 3223 and the upper end of the second connector 323.

The length LH of the first opening 81h1 in an up-and-down direction may be greater than the height h1 of the first connector 313 and/or the height h2 of the second connector 323. The length LH of the first opening 81h1 in an up-and-down direction may be greater than the sum of the height h1 of the first connector 313 and the thickness t1 of the first mount part 3123. The length LH of the first opening 81h1 in an up-and-down direction may be greater than the sum of the height h2 of the second connector 323 and the thickness t2 of the second mount part 3223. The thickness t1 of the first mount part 3123 may mean the length of the first mount part 3123 in an up-and-down direction, and the thickness t1 of the first mount part 3123 may be equal to the thickness of the first substrate 31. The thickness t2 of the second mount part 3223 may be equal to the thickness of the second substrate 32. The upper boundary of the first opening 81h1 may be disposed adjacent to the upper end of the first connector 313 and/or the upper end of the second connector 323.

For example, the length LH of the first opening 81h1 in an up-and-down direction may be less than 10 mm, preferably 6 mm. For example, the length LH of the first opening 81h1 in an up-and-down direction may be about 5 mm in the case of the display device 1 having a size of 55 inches or 65 inches, and the length LH of the first opening 81h1 in an up-and-down direction may be about 5.6 mm in the case of the display device 1 having a size of 75 or more inches.

The first mount part 3123 may be disposed adjacent to the left boundary of the first opening 81h1. For example, the left end of the first mount part 3123 may be disposed adjacent to the left boundary of the first opening 81h1. The second mount part 3223 may be disposed adjacent to the right boundary of the first opening 81h1. For example, the right end of the second mount part 3223 may be disposed adjacent to the right boundary of the first opening 81h1.

The length LM1 of the first mount part 3123 in a right-and-left direction may be less than the length LW of the first opening 81h1 in a right-and-left direction. For example, the length LM1 of the first mount part 3123 may be less than the half of the length LW of the first opening 81h1 in the right-and-left direction. The length LM2 of the second mount part 3223 in the right-and-left direction may be less than the length LW of the first opening 81h1 in the right-and-left direction. For example, the length LM2 of the second mount part 3223 may be less than the half of the length LW of the first opening 81h1 in the right-and-left direction. The sum of the length LM1 of the first mount part 3123 and the length LM2 of the second mount part 3223 may be equal to or less than the length LW of the first opening 81h1 in the right-and-left direction.

For example, the length LW of the first opening 81h1 in a right-and-left direction may be less than 50 mm. For example, the length LW of the first opening 81h1 in a right-and-left direction may be about 20 mm in the case of the display device 1 having a size 55 inches or 65 inches, and the length LW of the first opening 81h1 in the right-and-left direction may be about 38 mm in the case of the display device 1 having a size 75 or more inches.

Referring to FIG. 23, the first cable C1 and the second cable C2 may merge and may be connected to the second board P2. The third cable C3 and the fourth cable C4 may merge and may be connected to the second board P2.

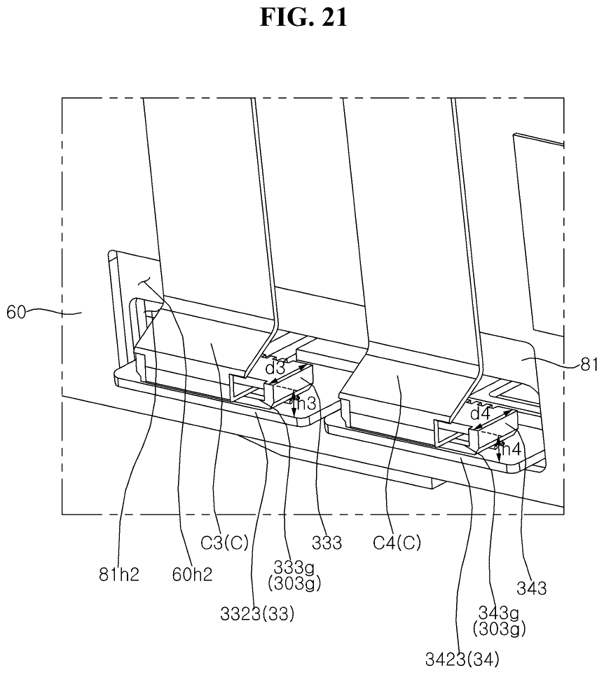

Referring to FIGS. 1 to 23, the display device 1 according to an aspect of the present disclosure may include the display panel 10, the frame 60 disposed behind the display panel 10, the housing 80 including the rear part 81 disposed between the display panel 10 and the frame 60 and the side part 82 intersecting the rear part 81 and extending along the lower side of the display panel 10, the substrate 30 coupled to the side part 82, and the plurality of light sources 37 disposed on the substrate 30 and configured to emit light, wherein the substrate 30 includes the body 301 extending along the lower side of the display panel 10 and the enlarged portion 302 extending from the body 301 forwards or backwards.

The display device 1 may further include the communication unit 500 disposed on the lower side of the display device 1 and capable of performing communication, and the enlarged portion 302 may including the extending portion 3021 extending from the body 301 forwards or backwards so as to correspond to the position of the communication unit 500.

The communication unit 500 may be positioned in the center of the lower side of the display device 1, and the width of the substrate 30 in the center of the lower side of the display device 1 may be greater than the width of the substrate 30 at the end of the lower side.

The display device 1 may further include the board P coupled to the frame 60 and disposed adjacent to the center of the substrate 30.

The substrate 30 may include the first substrate 31 extending toward the left end of the side part 82 from the center of the side part 82, and the second substrate 32 extending toward the right end of the side part 82 from the center of the side part 82, and the extending portion 3021 may include the first extending portion 3121 formed at the first substrate 31, and the second extending portion 3221 formed at the second substrate 32.

The length of the body 301 may be greater than or equal to 2 times a length of the extending portion 3021 and less than four times the length of the extending portion 3021 in a right-and-left direction.

The width of the body 301 in a forward-and-backward direction may be less than 4 times the width of the extending portion 3021 in the forward-and-backward direction.

The display device 1 may further include the board P disposed behind the frame 60, and the cable C connecting the board P to the substrate 30, the rear part 81 may include the flat part 811 extending upwards from the rear end of the side part 82, the projecting portion 812 projecting forwards from the flat part 811, and the opening 81h formed in the flat part 811 and spaced downwards apart from the projecting portion 812, and the enlarged portion 302 may include the mount part 3023 which projects backwards from the body 301, is disposed in the opening 81h, and is connected to the cable C.

The display device 1 may further include the optical layer 38 which is disposed between the display panel 10 and the rear part 81 and a side of which faces the plurality of light sources 37, and the projecting portion 812 may support the rear surface of the optical layer 38.

The substrate 30 may further include the connector 303 disposed on the mount part 3023, and the cable C may be coupled to the connector 303 to the front side from the rear side of the connector 303.

The length LW of the opening 81h in a right-and-left direction may be greater than 3 times the length LH of the opening 81h in an up-and-down direction.

The substrate 30 may include the first substrate 31 including the first mount part 3123 disposed in the opening 81h, the first body 311 extending leftwards from the front side of the first mount part 3123, and the first connector 313 disposed on the first mount part 3123, and the second substrate 32 including the second mount part 3223 disposed to a right side of the first mount part 3123, the second body 321 extending rightwards from the front side of the second mount part 3223, and the second connector 323 disposed on the second mount part 3223, and the cable C may include the first cable C1 coupled to the front side of the first connector 313 from the rear side of the first connector 313, and the second cable C2 coupled to the front side of the second connector 323 from the rear side of the second connector 323.

The length LW of the opening 81h in a right-and-left direction may be greater than 5 times the length LH of the opening 81h in an up-and-down direction.

The display device 1 may further include the spacer 39 disposed adjacent to the connector 303, coupled to the substrate 30, and surrounding the light sources 37, the spacer 39 may include the base 391 at least partially disposed between adjacent ones of the plurality of light sources 37 in which the distance between the base 391 and the side of the optical layer 38 is less than the distance between the light sources 37 and the side of the optical layer 38, and the protrusion 392 projecting downwards from the base 391, and the substrate 30 may include the hole 30h into which the protrusion 392 is inserted.

The spacer 39 may overlap the connector 303 in a forward-and-backward direction, and the thermal conductivity of the spacer 39 may be lower than the thermal conductivity of the substrate 30.

The display device 1 according to another aspect of the present disclosure may include the display panel 10, the housing 80 including the rear part 81 disposed behind the display panel 10 and the side part 82 intersecting the rear part 81 and extending along the lower side of the display panel 10, the substrate 30 coupled to the side part 82, the substrate 30 including the body 301 extending along the side part 82, the mount part 3023 projecting backwards from the body 301 and the connector 303 disposed on the mount part 3023, the plurality of light sources 37 disposed on the body 301 and configured to emit light, the board P disposed behind the rear part 81, and the cable C connected to the board P and coupled to the connector 303 in a horizontal direction.

The rear part 81 may include the flat part 811 extending upwards from the rear end of the side part 82, the projecting portion 812 projecting forwards from the flat part 811, and the opening 81h formed in the flat part 811 and spaced downwards apart from the projecting portion 812.

The display device 1 may further include the optical layer 38 disposed between the display panel 10 and the rear part 81, and the projecting portion 812 may support the rear surface of the optical layer 38.

The display device 1 may further include the spacer 39 coupled to the substrate 30 and surrounding the light sources 37, wherein the substrate 30 may further include the hole 30h to which the spacer 39 is coupled, wherein the spacer 39 includes the base 391 at least partially disposed between adjacent ones of the plurality of light sources 37 and the protrusion 392 projecting downwards from the base 391 and inserted into the hole 30h in the substrate 30, and wherein the spacer 39 overlaps the connector 303 in a forward-and-backward direction.

The display device 1 according to a further aspect of the present disclosure may include the display panel 10, the housing 80 including the rear part 81 disposed behind the display panel 10 and the side part 82 intersecting the rear part 81 and extending along the lower side of the display panel 10, the substrate 30 coupled to the side part 82, the light source 37 disposed on the substrate 30 so as to emit light, and the communication unit 500 disposed adjacent to the lower side of the display panel 10 and capable of performing communication, wherein the substrate 30 includes the body 301 extending along the side part 82, and the extending portion 3021 extending from the body 301 forwards or backwards so as to correspond to the position of the communication unit 500.

The effects of the display device according to the present disclosure will be described.

According to at least one embodiment of the present disclosure, it is possible to improve heat dissipation performance around the communication unit.

According to at least one embodiment of the present disclosure, it is possible to provide a structure in which the surface area of the substrate around the communication unit is increased.

According to at least one embodiment of the present disclosure, it is possible to provide a structure in which heat dissipation performance around the connector of the substrate is improved.

According to at least one embodiment of the present disclosure, it is possible to a structure in which the opening is formed in the housing to which the substrate is coupled around the connector of the substrate.

According to at least one embodiment of the present disclosure, it is possible to provide a structure in which the size of the opening in the housing, which is formed around the connector on the substrate, is minimized.

According to at least one embodiment of the present disclosure, it is possible to provide a structure in which the cable is fastened to the connector of the substrate in a horizontal direction.

According to at least one embodiment of the present disclosure, it is possible to provide a structure in which the board is disposed around the opening in the housing.

According to at least one embodiment of the present disclosure, it is possible to provide a structure in which the hole is formed in the substrate around the opening in the housing.

The additional scope of applicability of the present disclosure will be apparent from the above detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

Certain embodiments or other embodiments of the disclosure described above are not mutually exclusive or distinct from each other. Any or all elements of the embodiments of the disclosure described above may be combined with each other in configuration or function.

For example, a configuration “A” described in one embodiment of the disclosure and the drawings and a configuration “B” described in another embodiment of the disclosure and the drawings may be combined with each other. That is, even if the combination of the configurations is not explicitly described, the combination is possible except in the case where it is stated that the combination is impossible.

Although embodiments have been described with reference to a number of illustrative embodiments thereof, it should be understood that numerous other modifications and embodiments that fall within the scope of the principles of this disclosure can be devised by those skilled in the art. More particularly, various variations and modifications are possible in the component parts and/or arrangements within the scope of the disclosure, the drawings and the appended claims. In addition to variations and modifications in the component parts and/or arrangements, alternative uses will also be apparent to those skilled in the art.

What is claimed is:

1. A display device comprising:
a display panel;
a frame disposed behind the display panel;
a housing comprising a rear part disposed between the display panel and the frame and a side part intersecting the rear part and extending along a lower side of the display panel;
a substrate coupled to the side part; and
a plurality of light sources disposed on the substrate and configured to emit light,
wherein the substrate comprises:
a body extending along the lower side of the display panel; and
an enlarged portion extending from the body forwards or backwards.

2. The display device according to claim 1, further comprising a communication unit disposed on the lower side of the display device and capable of performing communication, and
wherein the enlarged portion comprises an extending portion extending from the body forwards or backwards so as to correspond to a position of the communication unit.

3. The display device according to claim 2, wherein the communication unit is positioned in a center of the lower side of the display device, and
wherein a width of the substrate in the center of the lower side of the display device is greater than a width of the substrate at an end of the lower side.

4. The display device according to claim 3, further comprising a board coupled to the frame and disposed adjacent to the center of the substrate.

5. The display device according to claim 2, wherein the substrate comprises:
a first substrate extending toward a left end of the side part from a center of the side part; and
a second substrate extending toward a right end of the side part from the center of the side part, and
wherein the extending portion comprises:
a first extending portion formed at the first substrate; and
a second extending portion formed at the second substrate.

6. The display device according to claim 2, wherein a length of the body is greater than or equal to 2 times a length of the extending portion and less than four times the length of the extending portion in a right-and-left direction.

7. The display device according to claim 2, wherein a width of the body in a forward-and-backward direction is less than 4 times a width of the extending portion in the forward-and-backward direction.

8. The display device according to claim 1, further comprising:
a board disposed behind the frame; and
a cable connecting the board to the substrate,
wherein the rear part comprises:
a flat part extending upwards from a rear end of the side part;
a projecting portion projecting forwards from the flat part; and
an opening formed in the flat part and spaced downwards apart from the projecting portion, and
wherein the enlarged portion comprises a mount part which projects backwards from the body, is disposed in the opening, and is connected to the cable.

9. The display device according to claim 8, further comprising an optical layer which is disposed between the display panel and the rear part and a side of which faces the plurality of light sources,
wherein the projecting portion supports a rear surface of the optical layer.

10. The display device according to claim 9, wherein the substrate further comprises a connector disposed on the mount part, and
wherein the cable is coupled to the connector to a front side from a rear side of the connector.

11. The display device according to claim 8, wherein a length of the opening in a right-and-left direction is greater than 3 times a length of the opening in an up-and-down direction.

12. The display device according to claim 8, wherein the substrate comprises:
a first substrate comprising a first mount part disposed in the opening, a first body extending leftwards from a front side of the first mount part, and a first connector disposed on the first mount part; and
a second substrate comprising a second mount part disposed to a right side of the first mount part, a second body extending rightwards from a front side of the second mount part, and a second connector disposed on the second mount part, and
wherein the cable comprises:
a first cable coupled to a front side of the first connector from a rear side of the first connector; and
a second cable coupled to a front side of the second connector from a rear side of the second connector.

13. The display device according to claim 12, wherein a length of the opening in a right-and-left direction is greater than 5 times a length of the opening in an up-and-down direction.

14. The display device according to claim 10, further comprising a spacer disposed adjacent to the connector, coupled to the substrate, and surrounding the light sources,
wherein the spacer comprises:
a base at least partially disposed between adjacent ones of the plurality of light sources, wherein a distance between the base and the side of the optical layer is less than a distance between the light sources and the side of the optical layer; and
a protrusion projecting downwards from the base, and
wherein the substrate comprises a hole into which the protrusion is inserted.

15. The display device according to claim 14, wherein the spacer overlaps the connector in a forward-and-backward direction, and
wherein a thermal conductivity of the spacer is lower than a thermal conductivity of the substrate.

16. A display device comprising:
a display panel;
a housing comprising a rear part disposed behind the display panel, and a side part intersecting the rear part and extending along a lower side of the display panel;
a substrate coupled to the side part, the substrate comprising a body extending along the side part, a mount part projecting backwards from the body, and a connector disposed on the mount part;
a plurality of light sources disposed on the body and configured to emit light;
a board disposed behind the rear part; and
a cable connected to the board and coupled to the connector in a horizontal direction.

17. The display device according to claim 16, wherein the rear part comprises:
a flat part extending upwards from a rear end of the side part;
a projecting portion projecting forwards from the flat part; and
an opening formed in the flat part and spaced downwards apart from the projecting portion.

18. The display device according to claim 17, further comprising an optical layer disposed between the display panel and the rear part,
wherein the projecting portion supports a rear surface of the optical layer.

19. The display device according to claim 16, further comprising a spacer coupled to the substrate and surrounding the light sources,
wherein the substrate further comprises a hole to which the spacer is coupled,
wherein the spacer comprises:
a base at least partially disposed between adjacent ones of the plurality of light sources; and
a protrusion projecting downwards from the base and inserted into the hole in the substrate, and
wherein the spacer overlaps the connector in a forward-and-backward direction.

20. A display device comprising:
a display panel;
a housing comprising a rear part disposed behind the display panel and a side part intersecting the rear part and extending along a lower side of the display panel;
a substrate coupled to the side part;
a light source disposed on the substrate so as to emit light; and
a communication unit disposed adjacent to the lower side of the display panel and capable of performing communication,
wherein the substrate comprises:
a body extending along the side part; and
an extending portion extending from the body forwards or backwards so as to correspond to a position of the communication unit.
